(19) United States
(12) Patent Application Publication
(10) Pub. No.: US 2019/0343243 A1
(43) Pub. Date: Nov. 14, 2019

(54) APPARATUS, SYSTEM AND METHOD FOR IMPROVING DECOR

(71) Applicant: Eric Rosenberg, Brooklyn, NY (US)

(72) Inventor: Eric Rosenberg, Brooklyn, NY (US)

(21) Appl. No.: 16/407,701

(22) Filed: May 9, 2019

Related U.S. Application Data
(60) Provisional application No. 62/669,388, filed on May 10, 2018.

(51) Int. Cl. A44B 17/00; F16M 13/02

(52) U.S. Cl. CPC A44B 17/0041; A47B 96/06; F16M 13/022

(57) ABSTRACT

The present invention discloses a versatile design system which has a base board, a face board, each board having a surface with at least one integrated securing mechanism. The securing mechanisms are made up an opposing end and a receiving end. Such securing mechanisms has either snap sockets, snap studs or alternate snap together mechanisms. The base board or surface may act as a wallboard wherein a plurality of face board attachments can easily be attached and removed without the use of tools, glue or other permanent bonding method. The present invention allows for a variety of components both decorative and functional with integrated snap studs or snap sockets or alternate snap together mechanisms.

### CLAIM OF PRIORITY

This application claims the benefit and priority of U.S. provisional patent application No. 62/669,388 filed May 10, 2018, the contents of which are hereby contained herein.

### FIELD OF THE EMBODIMENTS

The field of the embodiments relate to the field of design and art related products.

### BACKGROUND OF THE EMBODIMENTS

There is a need for better apparatuses, systems, and methods for improving decor of a household or office. The market has had many of the same products for many years each lacking a certain versatility and ease. The present invention seeks to solve this need.

### SUMMARY OF THE EMBODIMENTS

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

The present invention concerns an apparatus for improving decor; comprising: a base board; the board comprised with at least one securing mechanism with a receiving end; a face board; the board comprised with at least one securing mechanism with an opposing end. The apparatus further comprises a plurality of face board attachments which may be secured to the base board. The apparatus comprises at least one securing mechanism which are comprised of snap studs or snap sockets. The face board is configured to attach to a wall or other surface. The face board may also be used in a stand-alone format. The face board is configured to be flat or can be multi-dimensional. The at least one securing mechanism may be configured on a toy figurine or other articles such as signs, frames or any article capable of having a snap stud or socket. The base board may be configured with at least one securing mechanism with an opposing end while the face board may be configured with at least one securing mechanism with a receiving end. The at least one securing mechanism on the base board may be in varying patterns. The at least one securing mechanism on the face board may be in varying patterns.

The present invention also comprises a system for improving decor; comprising, a base board; the board comprised with at least one securing mechanism with a receiving end; a face board; the board comprised with at least one securing mechanism with an opposing end; a plurality of face board attachments which may be secured to the face board and to the base board.

The present invention discloses a versatile design system which is comprised of a base board, a face board, each board comprised of a surface with at least one integrated securing mechanism. The securing mechanism is comprised of an opposing end and a receiving end. Such securing mechanisms may be comprised of snap sockets, snap studs or alternate snap together mechanisms. The base board or surface may act as a wallboard wherein a plurality of face board attachments can easily be attached and removed without the use of tools, glue or other permanent bonding method. The present invention allows for a variety of components both decorative and functional with integrated snap studs or snap sockets or alternate snap together mechanism.

In addition to the foregoing, other objects, features, aspects and advantages of the present invention will be better comprehended through a careful reading of a detailed description provided herein below with appropriate reference to the accompanying drawings.

### BRIEF DESCRIPTION OF THE DRAWINGS

FIG. 1 shows a perspective view of a base board of the present invention.

FIG. 2 shows a perspective view of a receiving end of a securing mechanisms of the present invention.

FIG. 3 shows a perspective view of a face board of the present invention.

FIG. 4 shows a perspective view of an opposing end of a securing mechanism of the present invention.

FIG. 5 shows a perspective view of a shelf attachment of the present invention.

FIG. 6 shows a perspective view of a window shade attachment of the present invention.

FIG. 7 shows a perspective view of a tool with the securing mechanism of the present invention.

FIG. 8 shows a perspective view of a picture frame attachment of the present invention.

FIG. 9 shows a perspective view of a hook attachment of the present invention.

FIG. 10A-10C shows perspective views of various uses of the system of the present invention.

FIG. 11 shows a perspective view of an alternative hook attachment of the present invention.

FIG. 12 is an alternative perspective view of the base board of the present invention.

FIG. 13 is an alternative perspective view of the face board of the present invention.

FIG. 14 is a perspective view of an alternative hook attachment of the present invention.

FIG. 15 is a perspective view of the hook attachment secured to the present invention.

FIG. 16 is alternative perspective views of a tool with the securing mechanism of the present invention.

### DETAILED DESCRIPTION OF THE PREFERRED EMBODIMENT

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

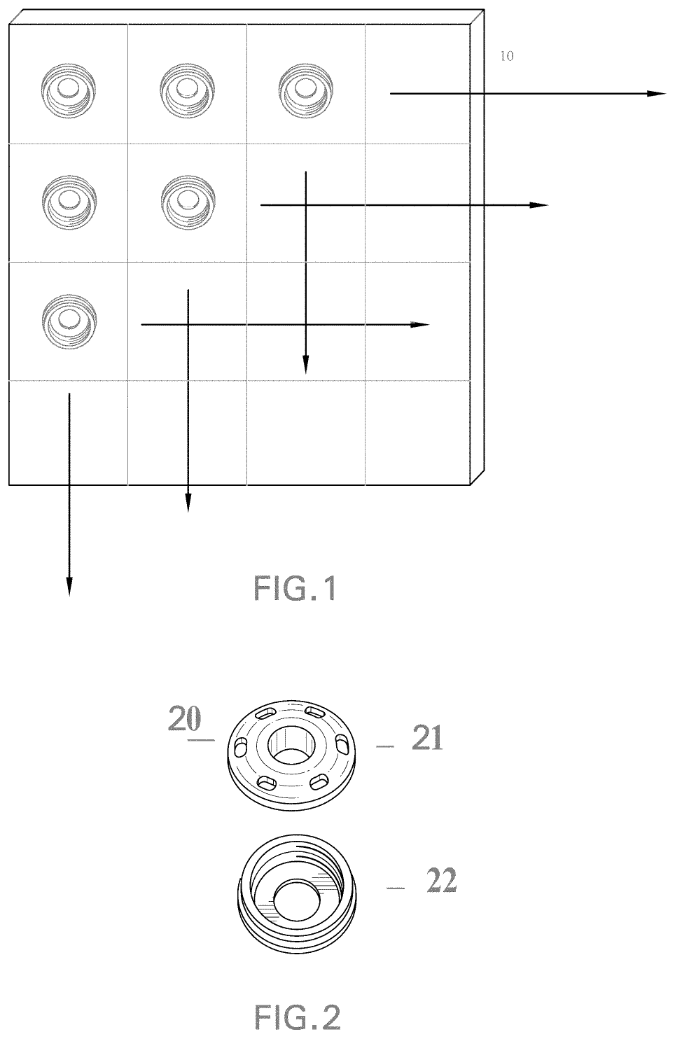

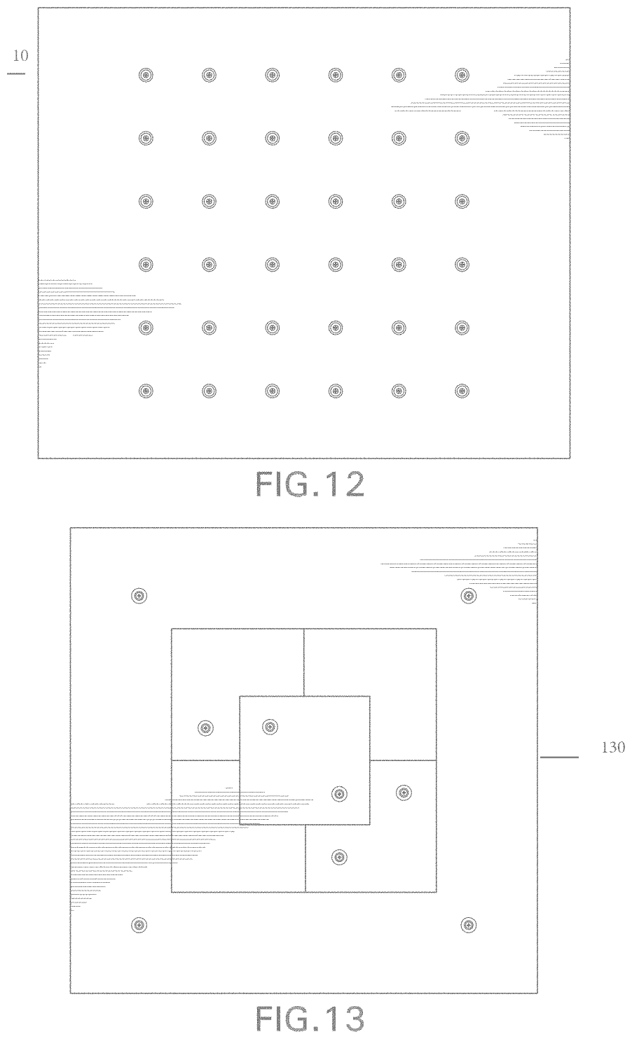

FIG. 1 shows the base board 10 of the present invention. The base board 10 may be comprised of a stable non-flexible or flexible material depending on the desired use. The base board may be comprised of different materials and varying widths, lengths, depths and dimensions. The base board 10 as shown in FIG. 12 may be comprised of a repeating series of securing mechanisms, each designed with a receiving end 21 and an opposing end 22. Such securing mechanism can be snap studs or snap sockets 20 (as shown in FIG. 2). These snap stud or snap sockets 20 are incorporated into the base board material either by attaching them after the board is made or by molding them while the board is made. The snap sockets 20 may be recessed within the board or protrude from the board. The snap socket 20 may be operational or not operational from either side of the board. The snap sockets 20 can be of a variety of types depending on the resistance necessary for a given application. Each snap socket 20 has been designed to receive an opposing end (or vice versa) of the integrated securing mechanism.

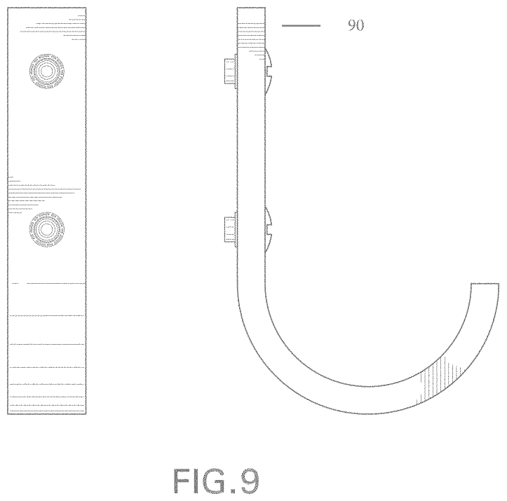

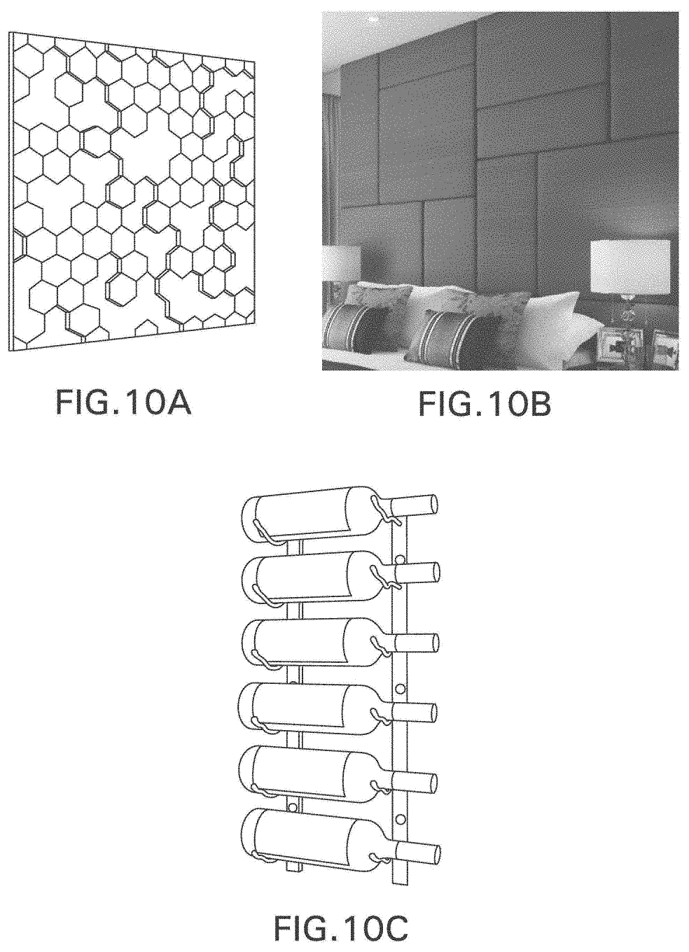

As shown in FIG. 10A-10C, the base board may be mounted on top of an existing wall, used as a wall surface in place of sheetrock or other common interior or exterior wall surfaces, used in a stand-alone capacity such a room divider or product display system, incorporated into furniture as an interior or exterior surface, or for any other use where connecting an item to a surface may be required. The base board may be made of any flat stable material such as wood, metal or plastic. It can also be made of a flexible material. The base board may have perforations in either a repeating, continuous or random pattern such that the snap sockets or receiving ends may have a desired effect for what will be inserted into the snap socket. The base board, face board and the snap sockets may be powered and electrified with a low voltage or high voltage system.

The perforations on the base board is configured to act as the female socket locking portion of a snap set. In another embodiment the base board is configured to act as the male socket locking portion of the snap set. Similarly, the face board may be configured with a male or female socket locking portion of a snap set. The locking mechanism for such securing mechanisms may be of any type commonly used for spring sockets such as a ring spring or a spring rod.

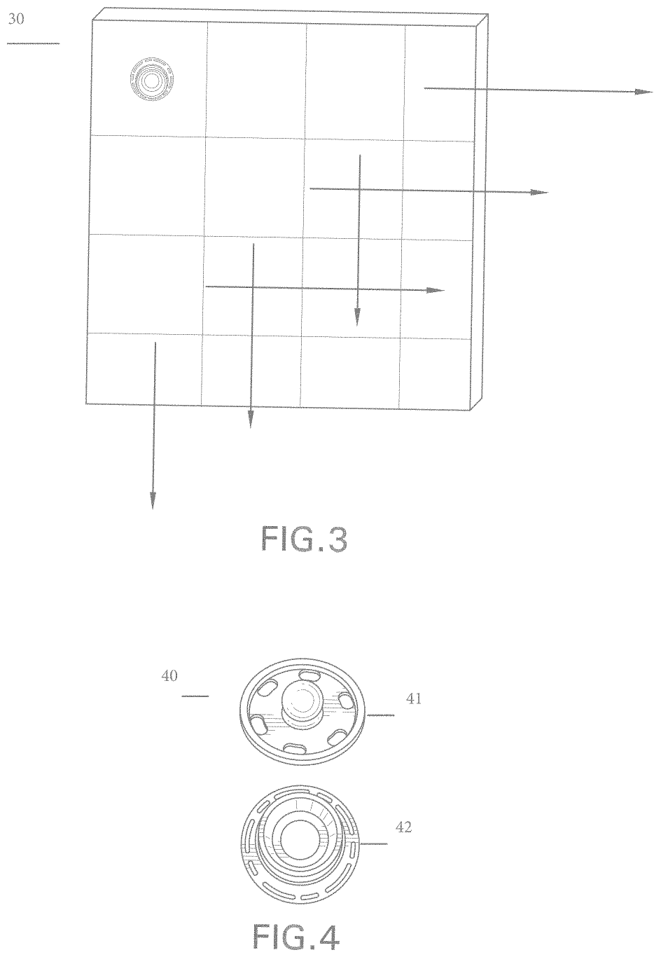

The present invention is also comprised of a face board 30 as shown in FIG. 3 and FIG. 13. The face board 30 may be comprised of a stable non-flexible or flexible material depending on the desired end use. The face board 30 may be comprised of different materials and varying widths, lengths, depths and dimensions. A series of snap studs 40 or opposing ends of the securing mechanism (as shown in FIG. 4) are incorporated into the face board 30 material either by attaching them after the board is made or by molding them while the board is made. The quantity of “snap studs” used will depend on the size shape and application of the desired and intended use. The snap studs protrude from the face board. The snap studs 40 may be of a variety of types depending on the resistance necessary for a given application or desired use. The snap sockets are comprised of an opposing end 41 and a receiving end 42.

The face board 30 is configured to integrate with a plurality of face attachments. The face board attachments may be configured with the male stud portion of a snap attached to the reverse side. The snap studs are configured to secure and interact with the perforations of snap sockets in located on the base board. There may be one or more snap studs on a given face board attachment as needed for the size and weight of the face board attachments. The decorative face attachments may be configured as solid or printed boards in a variety of materials, shapes, sizes, depths and colors. The face board attachments may be comprised of fabric upholstered boards in a variety of materials, shapes, sizes, depths and colors. The face board attachments may be comprised as dimensional boards in a variety of materials, shapes, sizes and depths and colors. In another embodiment, an intermediate board may be included and be configured with a at least one snap studs (or sockets) on one side and snap sockets (or studs) on the other side.

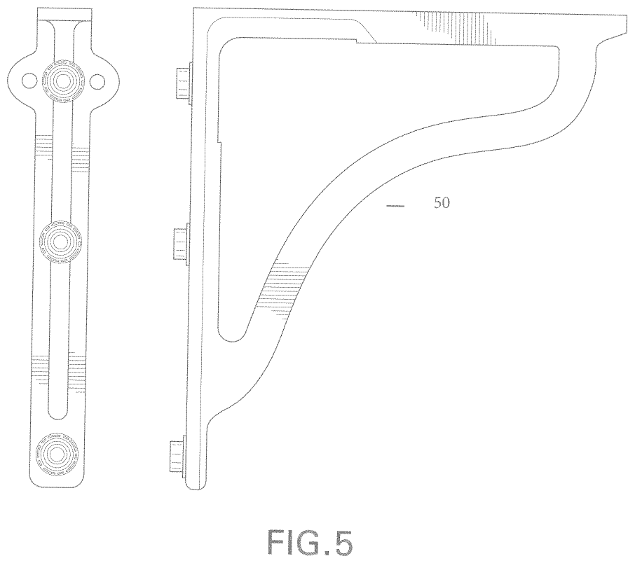

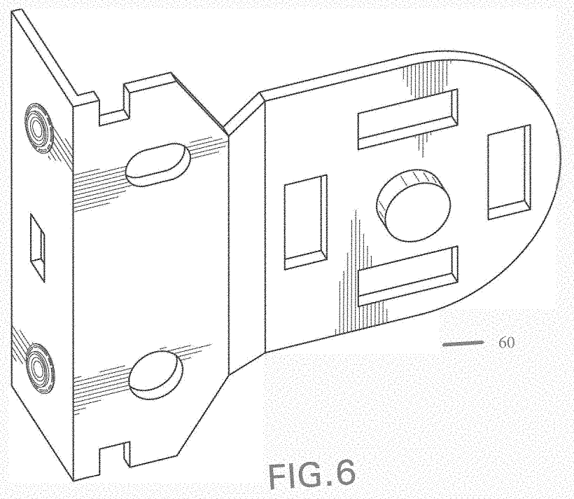

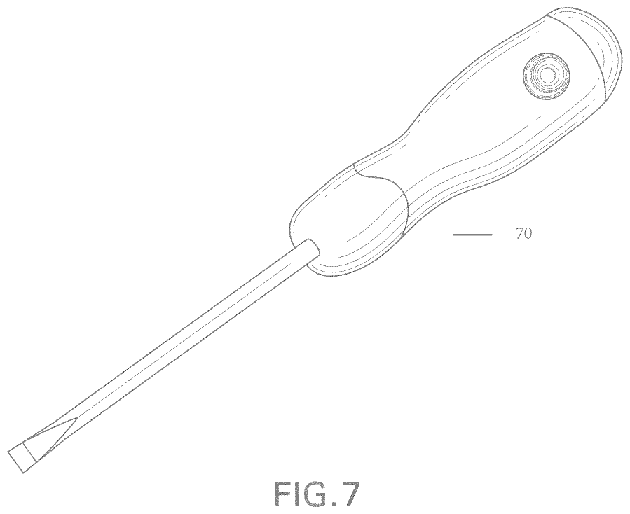

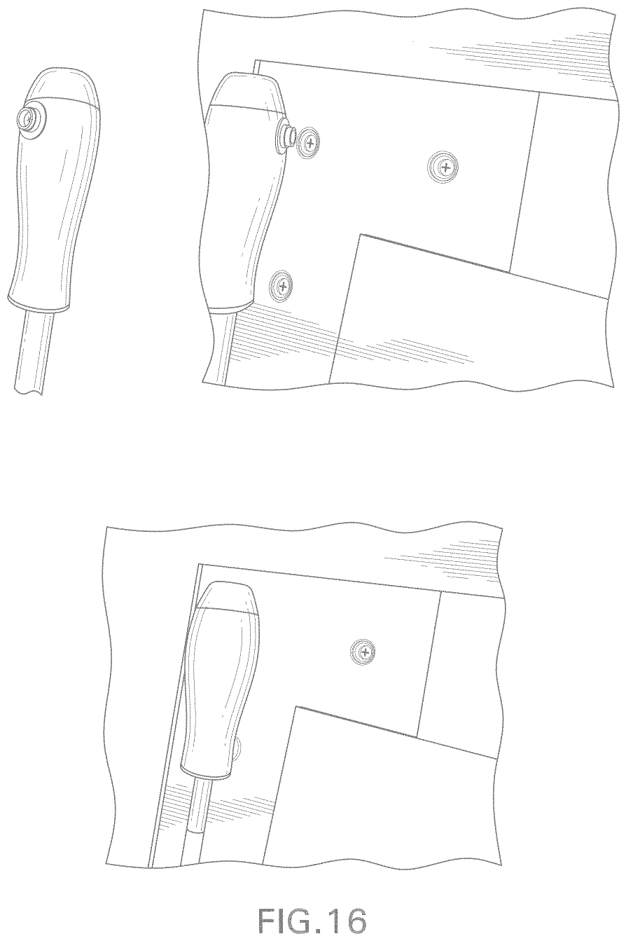

FIG. 5 shows a perspective view of a shelf attachment 50 of the present invention. FIG. 6 shows a perspective view of a window shade attachment 60 of the present invention. Other attachments may include hammers as well as screwdrivers or clocks. FIG. 7 shows a perspective view of a tool 70 with a securing mechanism of the present invention. FIG. 16 is alternative perspective view of the tool 70 with the securing mechanism of the present invention.

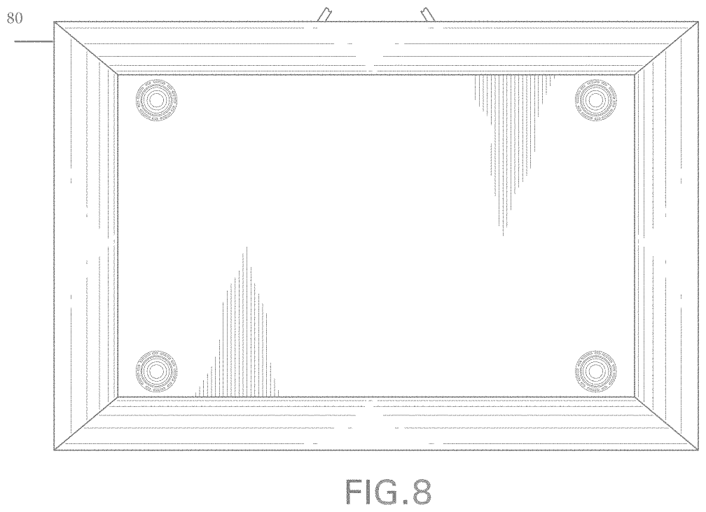

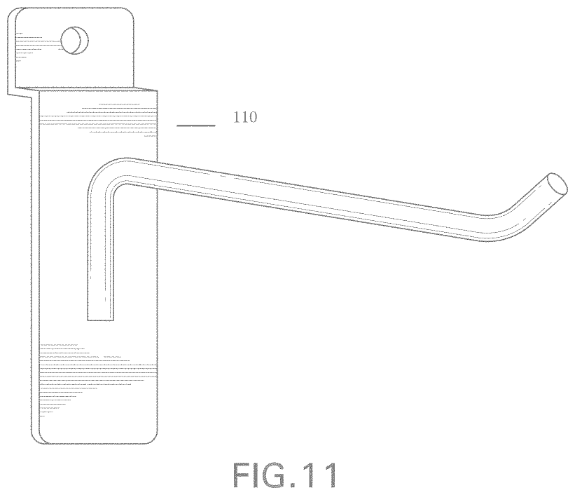

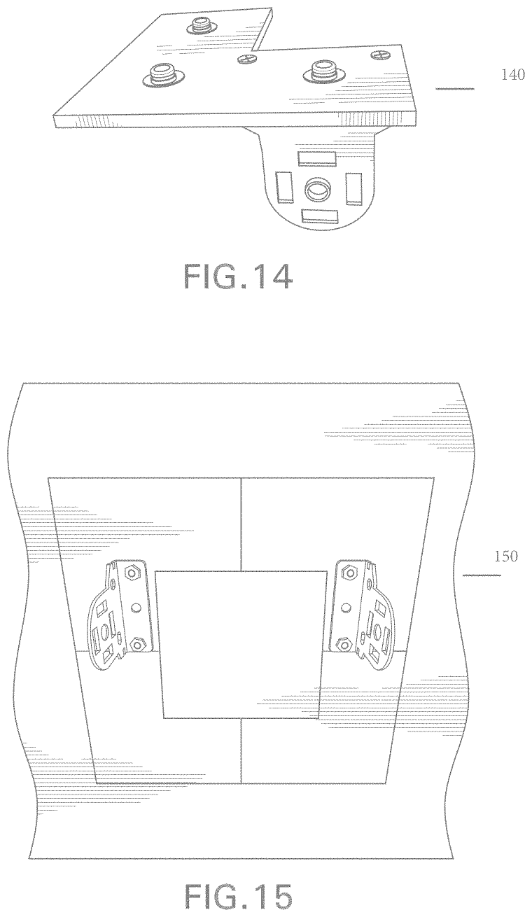

FIG. 8 shows a perspective view of a picture frame attachment 80 of the present invention. FIG. 9 shows a perspective view of a hook attachment 90 of the present invention. FIG. 10A-10C shows perspective views of various uses of the system of the present invention, such as art decor 10A, back board for a bed 10B and a wine rack 10C. FIG. 11 shows a perspective view of an alternative hook attachment 110 of the present invention. FIG. 14 is a perspective view of an alternative hook 140 attachment of the present invention. FIG. 15 is a perspective view of the hook attachment 150 secured to the present invention.

Other functional face board attachments may include at least one of a shelf brackets and shelves; cabinetry; clothing/accessory hooks; window treatment brackets; wine bottle holders; picture frames/art/mirrors; bulletin boards; signage; planters; whimsical design motifs; television brackets; headboards; lighting systems; tools and tool holders and store display fixtures.

In another embodiment the present invention may be configured to be sold as a kit to provide for the following intended or desired uses: snap together furniture; ceiling tiles; and flooring. In another embodiment, the base board additional holes may be created in the base board surface wherein a securing mechanism can be inserted and secured with a screw. In another embodiment, the base board may be comprised of plastic and as the board is manufactured, a custom or desired set of snap sockets and studs may be inserted to allow for a desired effect.

The securing mechanism may be adjusted to allow for the face board attachment to hold a greater weight. Securing mechanism can also be configured to secure wire so that the picture frames can be held. The securing mechanism may be configured to hold wire to secure a variety of objects. The items that can be attached to the base board can essentially be anything in which a snap can be attached to. This may include decorative boards in a variety of colors, patterns, materials, finishes. This also may include picture frames, shelf brackets, window treatment brackets, white boards, clothing hooks and lighting fixtures, hooks for jewelry and store display units. In an alternative embodiment of the present invention tools can be configured to include snaps so that they can be hung on the base board of the present invention. In another embodiment a series of letters with snaps that people can use to spell words. Securing mechanisms may be attached to a hat, jacket, and sneaker so they can be stored. In another embodiment, bookshelves, tables and cabinets may be configured with a base board, face board and a series of securing mechanism having an opposing and receiving end wherein multiple designs of furniture and household decor may be constructed. In another embodiment, the securing mechanism can be built into toys and toy figurines and or used for hanging towels, hats and articles of clothing. Similarly, the base board and face board can be used to hang whiteboards or other signage. In another embodiment of the present invention, the base board could be equipped with either receiving or opposing ends of the securing mechanism and the face board could be configured with the corresponding receiving or opposing ends of the securing mechanism. In another embodiment the snap studs and sockets may be on either the face board or the base board.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An apparatus for improving decor; comprising:
a base board; the board comprised with at least one securing mechanism with a receiving end;
a face board; the board comprised with at least one securing mechanism with an opposing end.

2. The apparatus of claim 1, further comprising a plurality of face board attachments which may be secured to the base board.

3. The apparatus of claim 1, wherein the at least one securing mechanism is comprised of snap studs or snap sockets.

4. The apparatus of claim 1, wherein the face board is configured to attach to a wall or other surface.

5. The apparatus of claim 1, wherein the face board is configured as a stand-alone article.

6. The apparatus of claim 1, wherein the face board is configured to be flat.

7. The apparatus of claim 1, wherein the face board is configured to be multi-dimensional.

8. The apparatus of claim 1, further comprising the at least one securing mechanism configured on a toy figurine or other article.

9. The apparatus of claim 1, further comprising a base board configured with at least one securing mechanism with an opposing end.

10. The apparatus of claim 1, further comprising a face board configured with at least one securing mechanism with a receiving end.

11. The apparatus of claim 1, wherein the at least one securing mechanism on the base board may be in varying patterns.

12. The apparatus of claim 1, wherein the at least one securing mechanism on the face board may be in varying patterns.

13. The apparatus of claim 1, wherein the at least one securing mechanism is integrated into the base or face board.

14. The apparatus of claim 1, further comprising an intermediate board having at least one securing mechanism on either side.

15. A system for improving decor; comprising:
a base board; the board comprised with at least one securing mechanism with a receiving end;
a face board; the board comprised with at least one securing mechanism with an opposing end;
a plurality of face board attachments which may be secured to the face board and to the base board.

16. The system of claim 1, wherein the base board is comprised with at least one securing mechanism with an opposing end.

17. The system of claim 1, wherein the face board is comprised with at least one securing mechanism with a receiving end.
